(19) United States
(12) Patent Application Publication
(10) Pub. No.: US 2020/0388459 A1
(43) Pub. Date: Dec. 10, 2020

(54) SILICON FIELD EFFECT EMITTER

(71) Applicant: Siemens Healthcare GmbH, Erlangen (DE)

(72) Inventors: Jörg Freudenberger, Kalchreuth (DE); Anja Fritzler, Erlangen (DE)

(21) Appl. No.: 16/891,411

(22) Filed: Jun. 3, 2020

(30) Foreign Application Priority Data
Jun. 5, 2019 (DE) 19178363.8

(51) Int. Cl. H01J 1/304; H01J 1/46; H01J 3/02; H01J 35/06

(52) U.S. Cl. CPC H01J 1/3048; H01J 1/46; H01J 2201/30453; H01J 35/065; H01J 2235/06; H01J 3/021

(57) ABSTRACT

A system and method for generating X-ray radiation in a predefined spatial distribution on an anode. The system includes an anode, a first switching device, a second switching device, a control unit, and an emitter with multiple field effect emitter needles. At least one field effect emitter needle of the multiple field effect emitter needles includes a diameter of less than 1 μm and silicon. A first group of the multiple field effect emitter needles may be activated or deactivated by the first switching device. A second group of the multiple field effect emitter needles may be activated or deactivated by the second switching device. The first group differs from the second group. The control unit is configured to actuate the first switching device and the second switching device.

### CROSS REFERENCE TO RELATED APPLICATIONS

This application claims the benefit of EP 19178363.8 filed on Jun. 5, 2019, which is hereby incorporated by reference in its entirety.

### FIELD

Embodiments relate to an X-ray tube, an X-ray device, and a method for generating X-ray radiation in a predefined spatial distribution on an anode.

### BACKGROUND

X-ray radiation may be generated in an X-ray tube by bombarding an anode with electrons. A resolving power of the X-ray tube may be determined by a spatial distribution of the electrons when they strike the anode. The electrons are conventionally emitted by a thermionic tungsten emitter, a carbon field effect emitter, and/or a field effect emitter with a dispenser cathode. Common to the emitters described above is the fact that an electron emission density may be limited to approximately 3 A/cm\hat{ }2. However, an electron emission density of approximately 10 A/cm\hat{ }2 may be necessary for an imaging examination, which is why the electrons of the conventional emitters are normally focused on the anode, for example by a deflection unit. Focusing the electrons typically depends on an acceleration voltage between a cathode with an emitter and an anode as well as a space-charge density of the electrons. Thus, the spatial distribution of the electrons normally changes as a function of the acceleration voltage and/or an intensity of the electron beam.

An electron emission apparatus including at least one electron emitter and at least one barrier grid is known from the as yet unpublished application EP 18158898.

The as yet unpublished application EP 18154147 discloses a thermionic emission apparatus including a flat emitter and a connectable field effect electron emitter.

Guerrera et al. describe a silicon field effect emitter with an electron emission density above 100 A/cm\hat{ }2 in “Silicon Field Emitter Arrays with Current Densities Exceeding 100 A/cm2 at Gate Voltages Below 75 V” (IEEE ELECTRON DEVICE LETTERS, VOL. 37, NO. 1, JANUARY 2016).

### BRIEF SUMMARY AND DESCRIPTION

The scope of the present disclosure is defined solely by the appended claims and is not affected to any degree by the statements within this summary. The present embodiments may obviate one or more of the drawbacks or limitations in the related art.

Embodiments provide an X-ray tube, an X-ray device, a method for generating X-ray radiation in a predefined spatial distribution on an anode and an associated computer program product, in which the emission of the electrons is controlled more flexibly.

In an embodiment, the X-ray tube includes an anode, a first switching device, a second switching device, a control unit and an emitter including multiple field effect emitter needles. At least one field effect emitter needle of the multiple field effect emitter needles includes a diameter of less than 1 μm and silicon. A first group of the multiple field effect emitter needles may be activated or deactivated by the first switching device. A second group of the multiple field effect emitter needles may be activated or deactivated by the second switching device. The first group differs from the second group and the control unit is configured to control the first switching device and the second switching device.

The emitter with the multiple field effect emitter needles may be configured in accordance with the silicon field effect emitter from Guerrera et al. The at least one field effect emitter needle may include a diameter between 10 nm and 800 nm, for example between 100 nm and 500 nm, for example between 150 nm and 250 nm, for example 200 nm. The at least one field effect emitter needle contains no carbon and/or only silicon. Each field effect emitter needle may entirely include silicon and/or partially include silicon. The emitter includes for example between 2 and 25000000, for example between 100000 and 10000000 field effect needles per square millimeter. The multiple field effect emitter needles may be spaced apart from one another by between 10 nm and 500 μm, for example between 200 nm and 1 μm. The multiple field effect emitter needles may be aligned in parallel.

The at least one field effect emitter needle, for example each field effect emitter needle, may be activated with a gate emitter voltage greater than 0V, less than 1 kV, or less than 200 V, for example less than 100 V. The gate emitter voltage forces an electrical field strength at a tip of the activated field effect emitter needles such that electrons are emitted by the activated field effect emitter needles. The first group and/or the second group may be deactivated by applying a gate emitter voltage equal to or less than 0V.

The anode may be a stationary anode or a rotary anode. The anode for example includes tungsten to generate X-ray radiation from the electrons. The rotary anode may be part of a rotary piston X-ray tube or a rotary anode X-ray tube. The X-ray tube may be evacuated. To accelerate the electrons emitted by the activated field effect emitter needles an acceleration voltage may be applied between the emitter and the anode. The acceleration voltage is for example provided by a voltage supply. The X-ray tube for example includes the voltage supply for applying a first acceleration voltage or a second acceleration voltage between the emitter and the anode. The first acceleration voltage may differ from the second acceleration voltage or be identical to the second acceleration voltage. The control unit may activate the first switching device or the second switching device as a function of the acceleration voltage applied.

The multiple field effect emitter needles may be switched in groups, for example activated or deactivated in alternation. The first group and/or the second group may include at least one field effect emitter needle up to 100% of the multiple field effect emitter needles. The first group and the second group may differ in at least one field effect emitter needle. The first group and the second group may include at least partially the same field effect emitter needles. An intersecting set of the first group with the second group may be unequal to zero. Alternatively, the intersecting set may be empty. The first group and the second group are not identical. The second group may include the field effect emitter needles that are deactivated, while at the same time the first group of the multiple field effect emitter needles are activated. Alternatively, or additionally the second group may include the field effect emitter needles that are activated or deactivated offset in time relative to the multiple field effect emitter needles in the first group. The field effect emitter needles in the first group may be activated or deactivated in alternation with the field effect emitter needles in the second group.

The multiple field effect emitter needles may be distributed in two spatial directions and/or arranged in a grid shape. The arrangement of the field effect emitter needles may be such that the emitter is a two-dimensional emitter. The multiple field effect emitter needles may be arranged in a plane and/or are oriented in parallel. The multiple field effect emitter needles may be arranged linearly or multidimensionally.

An envelope of the field effect emitter needles in the first group may at least partially overlap an envelope of the field effect emitter needles in the second group. For example, a midpoint of the envelope of the field effect emitter needles in the first group may lie inside the envelope of the field effect emitter needles in the second group. The midpoint of the envelope of the field effect emitter needles in the first group and a midpoint of the envelope of the field effect emitter needles in the second group may be substantially congruent. The envelope includes, for example, the outermost activated field effect emitter needles in the respective group and/or forms, for example, a rectangle or a circle. The envelope may be an envelope curve. The field effect emitter needles in the first group may be interlaced at least partially with the field effect emitter needles in the second group.

Each field effect emitter needle may include a switch that is connected to the first switching device and/or the second switching device. The switch may be a field effect emitter needle voltage supply for the provision of the gate emitter voltage. The first switching device and the second switching device may be mapped logically in program code, while for example, the switches of the multiple field effect emitter needles may electronically switch the emission of electrons at the respective field effect emitter needles. For example, if the first switching device and the second switching device are logically mapped, the first group and the second group may be repeatedly populated with the multiple field effect emitter needles. The control unit may select the field effect emitter needles for the first group and/or the field effect emitter needles for the second group, for example as a function of a measuring protocol. The X-ray tube may be used for the different measuring protocols, without the field effect emitter needles having to be electronically interconnected again. The groups of the multiple field effect emitter needles may be activated by the control unit such that the control unit programs the first switching device and/or the second switching device with the respective switches of the first group and/or the second group.

The switching of the emission of the electrons may correspond to the activation or deactivation of the first group and/or the second group. The switching of the emission of the electrons may include a complete blocking, for example on deactivation, and/or a stepless regulation, for example on activation, of the emission of the electrons. The stepless regulation of the emission of the electrons may correspond to a setting of an emission current of the respective activated field effect emitter needle. The stepless regulation may be a function of the gate emitter voltage.

The activation and deactivation, for example the group-related switching offset in time, of the field effect emitter needles may take place repeatedly with a frequency higher than 0.1 Hz, higher than 10 kHz, or higher than 1 MHz. The activation and deactivation that is high-frequency compared to a thermionic emitter is advantageous because the heat distribution inside the emitter may be efficiently controlled and/or a total number of the emitted electrons, for example a total emission current as a sum of the emission currents, may be flexibly adjusted.

The first switching device may be linked to the first group, for example via the switches of the respective field effect emitter needles in the first group and/or the second switching device is linked to the second group, for example via the switches of the respective field effect emitter needles in the second group. The linkage corresponds to an electronic interconnection. The control unit may be configured to actuate the first switching device and the second switching device such that by sending a first activation signal the first switching device for example activates the first group of the multiple field effect emitter needles, for example the switches thereof, and/or by sending a second activation signal the second switching device for example activates the second group of the multiple field effect emitter needles, e.g. the switches thereof. The first switching device may activate the field effect emitter needles in the first group in accordance with the activation signal, for example by the switches of the field effect emitter needles in the first group being activated. The actuation additionally includes deactivation, for example by sending a deactivation signal, as an alternative to activation.

The X-ray tube may provide the electron emission density needed for an imaging examination, for example of approximately 10 A/cm\hat{ }2, on the anode. Only a part, for example the first group or the second group, of the multiple field effect emitter needles is activated. If not all field effect emitter needles are activated, this is advantageous for a service life of the X-ray tube, for example for the emitter with the multiple field effect emitter needles, if heat generation inside the emitter is homogeneously distributed. The longer service life is advantageous in respect of reducing costs.

The X-ray tube includes no electron beam deflection unit between the emitter and the anode. A conventional electron beam deflection unit includes a magnetic deflection unit. The first group and/or the second group are selected in terms of number and/or arrangement such that the X-ray tube does not require an electron beam deflection unit between the emitter and the anode. As a result, the weight of the X-ray tube is lower than a weight of a conventional X-ray tube with a deflection unit. The X-ray tube may be less expensive than the conventional X-ray tube. Furthermore, control of the electron beam is simplified if the X-ray tube is less complex because of the absence of a deflection unit.

The multiple field effect emitter needles may be divided and/or connected in groups and provide the field effect emitter needles to be activated as a function of different measuring protocols for the imaging examination. The spatial distribution of the electrons on the anode may be unchanged. The various measuring protocols may differ in an acceleration voltage, in an X-ray radiation dose and/or in a resolving power. The multiple field effect emitter needles in the first group and/or the multiple field effect emitter needles in the second group may for example be determined by a manufacturer of the X-ray tube and/or a user and/or a physician. Determining the field effect emitter needles for the respective group may correspond to programming the emitter. In addition to the first group and the second group, further groups may be determined as field effect emitter needles. The control unit may, as a function of the measuring protocol, determine a number of switching devices and the field effect emitter needles associated in a group with the respective switching device.

The activation in groups of the field effect emitter needles provides the electron beam to be shaped flexibly. The field effect emitter needles in the first group and the field effect emitter needles in the second group are arranged such that a predefined spatial distribution of the electrons striking the anode is substantially independent of the activated group.

Embodiments provide that the first group differs from the second group in an arrangement of the multiple field effect emitter needles. The arrangement is not congruent in respect of a reference point. If the field effect emitter needles in both the groups differ in their arrangement, the shape of the electron beam may be influenced by physical interactions of the emitted electrons with one another and thus the spatial distribution of the electrons. Taking the physical interactions into account provides the deflection unit to be omitted. The physical interactions include electrostatic effects because of the space-charge density of the electrons. The arrangement of the activated field effect emitter needles may for example be star-shaped or circular or arbitrary.

Embodiments provide that the first group differs from the second group in the number of the multiple field effect emitter needles. If the number varies, a difference in the arrangement may be automatically present. The variation in the number of multiple field effect emitter needles in the respective group provides the emission current to be scaled.

Embodiments provide that the first group differs from the second group in the acceleration voltage applied. As a function of the acceleration voltage the heat distribution may be distributed across the field effect emitter needles.

The arrangement and/or the number of field effect emitter needles and/or the acceleration voltage applied may be determined for example in a simulation of the X-ray tube or during a test measurement with the X-ray tube and/or saved group-specifically in a memory unit of the control unit.

Embodiments provide that the first group differs from the second group in the number and arrangement of the multiple field effect emitter needles and the acceleration voltage applied. The physical interactions between the emitted electrons, for example because of the space-charge density, may be taken into account such that the spatial distribution of the electrons on the anode is identical independently of the activated switching device. The electrons strike the anode in the same spatial distribution, regardless of which field effect emitter needles are activated. The X-ray radiation dose of the X-ray radiation generated by the electrons is independent of the activated field effect emitter needles. The X-ray radiation dose may depend on the acceleration voltage applied. The X-ray radiation dose corresponds to an intensity of the X-ray radiation.

Embodiments provide for the first switching device and/or the second switching device to be configured for activating the respective multiple field effect emitter needles such that each activated field effect emitter needle supplies a saturation current. This embodiment may be advantageous if the first group differs from the second group in the number of the multiple field effect emitter needles. The total emission current of the emitter may correlate with the number of activated field effect emitter needles. The total emission current may be controlled flexibly. According to Guerrera et al. the saturation current may be determined by a specific structure of the multiple field effect emitter needles. The specific structure includes, for example, an effective cross-sectional surface and/or a dosing density of the respective field effect emitter needle and/or a saturation velocity of the electrons. Operating the field effect emitter needles in saturation may be advantageous because as a result the emission current of the respective activated field effect emitter needle is kept constant. The actuation of the first switching device and the second switching device includes a binary switching of the first group or the second group, for example without stepless current regulation. In saturation the respective activated field effect emitter needle supplies a constant current, regardless of the electric field applied. The respective activated field effect emitter needle may include a current limitation. Compared to a silicon field effect emitter a conventional carbon field effect emitter may be destroyed by an excessive electric field because the conventional carbon field effect emitter may not have any current limitation. The emission current typically cannot be adjusted steplessly. The gate emitter voltage may be greater than or equal to a saturation voltage.

In an embodiment, the X-ray device includes the X-ray tube and the X-ray detector. Using the X-ray detector, the X-ray radiation used to X-ray a patient during an imaging examination may be detected. For example, a medical image may be reconstructed using the detected X-ray radiation. The medical image may for example be provided to the user or the physician on a display unit and/or stored in a radiology information system and/or in a PACS image archiving system. The X-ray device may be configured as a conventional X-ray system, as a single-source computer tomography system, as a mammography system, or as a C-arm angiography system.

Embodiments provide for the X-ray device for an imaging examination to be configured with an alternating acceleration voltage. The alternating acceleration voltage may be predefined in accordance with the dual-energy measuring protocol. The acceleration voltage may alternate, for example, in a frequency greater than 1 Hz, greater than 100 Hz, or greater than 1 kHz. The alternating acceleration voltage may be switched rapidly by the respective group of field effect emitter needles. Materials inside the patient may for example be distinguished. The materials normally include an attenuation coefficient as a function of the acceleration voltage. The materials may be tissue and/or bone and/or contrast agent. The X-ray device may include only a single X-ray tube, or no other X-ray tube as in the case of a conventional dual-energy X-ray device. In other words, no other X-ray tube is required for the imaging examination in accordance with the dual-energy measuring protocol.
Embodiments provide a method for generating X-ray radiation in a predefined spatial distribution on an anode that includes the following steps: predefining the spatial distribution of electrons striking the anode of an X-ray tube; selecting a group of multiple field effect emitter needles of an emitter of the X-ray tube as a function of an acceleration voltage; and activating the selected group of multiple field effect emitter needles, as a result of which X-ray radiation is generated in the predefined spatial distribution on the anode.

The spatial distribution corresponds to a modulation transfer function. Predefining the spatial distribution may for example be affected using an input, for example from a keyboard, a mouse, and/or a screen, by the user and/or physician. Alternatively, for example a control unit may automatically determine the spatial distribution, for example as a function of the measuring protocol predefined by the user and/or physician.

Selecting the group may include determining an arrangement, for example a number, of multiple field effect emitter needles. Selecting the group is may be affected automatically, for example in the control unit, for example as a function of the measuring protocol predefined by the user and/or physician.

The control unit may activate the selected group of multiple field effect emitter needles, for example by the switching device and/or the switches of the respective field effect emitter needles. Activation may include the application of a gate emitter voltage. By activating the selected group of multiple field effect emitter needles, electrons are emitted and are oriented onto the anode such that when the electrons strike the anode in the predefined spatial distribution the X-ray radiation is generated.

The computer program product may be a computer program or may include a computer program. The computer program product includes the program code. The method may be carried out in a defined and repeatable manner and monitoring may be performed by a passing on. The computer program product is may be configured such that the computer unit may carry out the method steps by the computer program product. The program code may be loaded into a memory of the computer unit and may be carried out by a processor of the computer unit with access to the memory. If the computer program product, e.g. the program code, is carried out in the computer unit, the embodiments of the method described may be carried out. The computer program product is, for example, stored on a physical computer-readable medium and/or digitally as a data packet in a computer network. The computer program product may represent the physical, computer-readable medium and/or the data packet in the computer network. Embodiments may also proceed from the physical computer-readable medium and/or the data packet in the computer network. The physical, computer-readable medium may be connected directly to the computer unit, for example in that the physical computer-readable medium is inserted into a DVD drive or into a USB port, whereby the computer unit may access the physical computer-readable medium, for example in read-only mode. The data packet may be called from the computer network. The computer network may include the computer unit or may be indirectly connected by a Wide Area Network (WAN) or a (Wireless) Local Area Network (WLAN or LAN) to the computer unit. For example, the computer program product may be stored digitally on a cloud server at a storage location of the computer network, and transferred by the WAN via the internet and/or by the WLAN or LAN to the computer unit, by the calling of a download link that points to the storage location of the computer program product.

### BRIEF DESCRIPTION OF THE FIGURES

FIG. 1 depicts an emitter including a first group of multiple field effect emitter needles according to an embodiment.

FIG. 2 depicts an emitter including a second group of multiple field effect emitter needles according to an embodiment.

FIG. 3 depicts trajectories of the emitted electrons as a function of the acceleration voltage applied according to an embodiment.

FIG. 4 depicts an X-ray device according to an embodiment.

FIG. 5 depicts a method for generating X-ray radiation in a predefined spatial distribution on an anode according to an embodiment.

### DETAILED DESCRIPTION

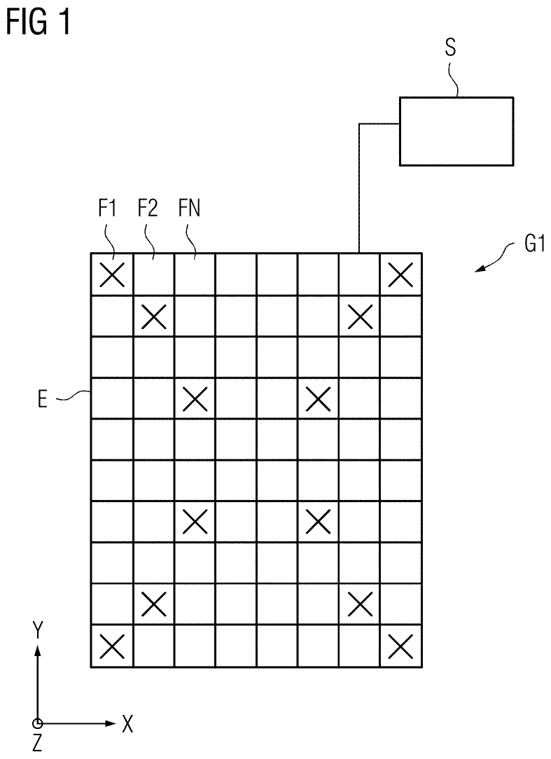

FIG. 1 depicts a top view of an emitter E with a first group G1 of multiple field effect emitter needles F1, F2, FN in an embodiment. The multiple field effect emitter needles F1, F2, FN are arranged distributed in two spatial directions and in the embodiment include 8×10 field effect emitter needles.

The first group G1 of multiple field effect emitter needles F1, F2, FN is characterized by crosses and in the embodiment includes 12 field effect emitter needles. The first number is therefore 12. The first group may contain more or fewer than 12 field effect emitter needles. If the control unit S actuates and activates a switching device not shown in FIG. 1, the first group G1 of multiple field effect emitter needles F1, F2, FN emits electrons. The electrons are accelerated by a first acceleration voltage, that for example lies between 30 kV and 150 kV, for example at 120 kV.

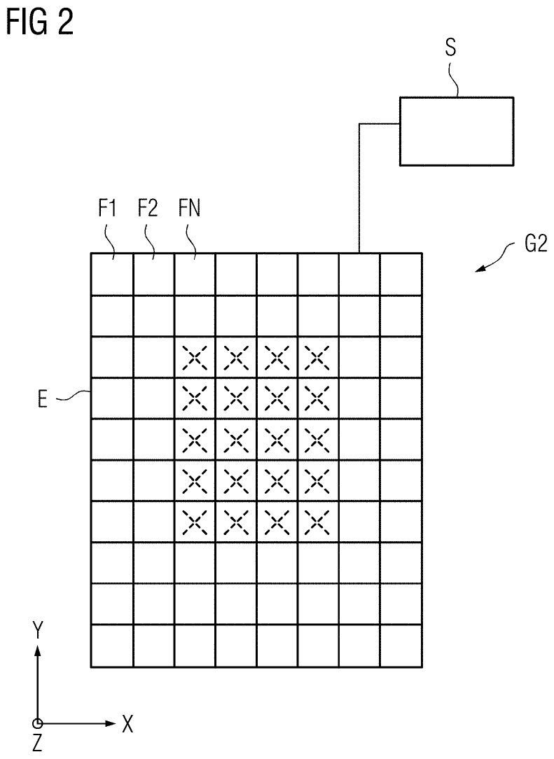

The first group G1 includes a first arrangement and the first number of multiple field effect emitter needles F1, F2, FN, that differs from the embodiment depicted in FIG. 2

FIG. 2 depicts a top view of an emitter E with a second group G2 of multiple field effect emitter needles F1, F2, FN in an embodiment. The second group G2 differs from the first group G1. The second group G2 has a second arrangement and a second number of multiple field effect emitter needles F1, F2, FN. The second number is 20. The second group G1 of multiple field effect emitter needles F1, F2, FN is characterized by dashed crosses.

The electrons emitted from the second group G2 are accelerated by a second acceleration voltage that, for example, lies between 30 kV and 150 kV, for example at 80 kV.

The activated field effect emitter needles in the second group G2 in FIG. 2 are more compactly arranged than the activated field effect emitter needles in the first group G1 in FIG. 1.

The groups G1, G2 of multiple field effect emitter needles shown in FIG. 1 and FIG. 2 may be activated offset in time, for example one after the other, for example in accordance with the dual-energy measuring protocol.

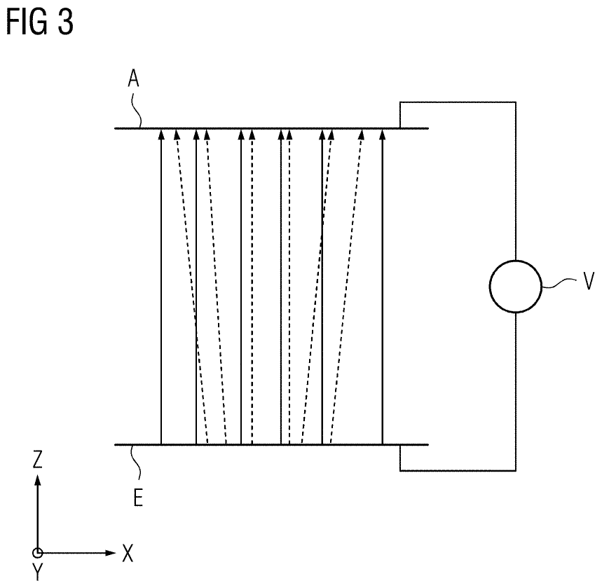

FIG. 3 schematically depicts trajectories of the emitted electrons as a function of the acceleration voltage applied offset in time. The electrons are emitted if the gate emitter voltage is correspondingly provided by a field effect emitter needle voltage supply not shown in FIG. 3. The electrons emitted by the emitter E are accelerated by a voltage supply V toward an anode A, for example in a vacuum.

The solid trajectories differ from the dashed trajectories in the number of emitting field effect emitter needles and thus in the effect of the physical interactions to one another. The solid trajectories show for example electrons from the configuration shown in FIG. 1 and the dashed trajectories show the configuration shown in FIG. 2, if the first number in FIG. 1 is smaller than the second number in FIG. 2. Because of the higher emission current and the associated higher space-charge density of the form of embodiment shown in FIG. 2, as a result of in which comparatively stronger physical interactions occur between the electrons, the dashed trajectories deviate more strongly from one another than the solid trajectories.

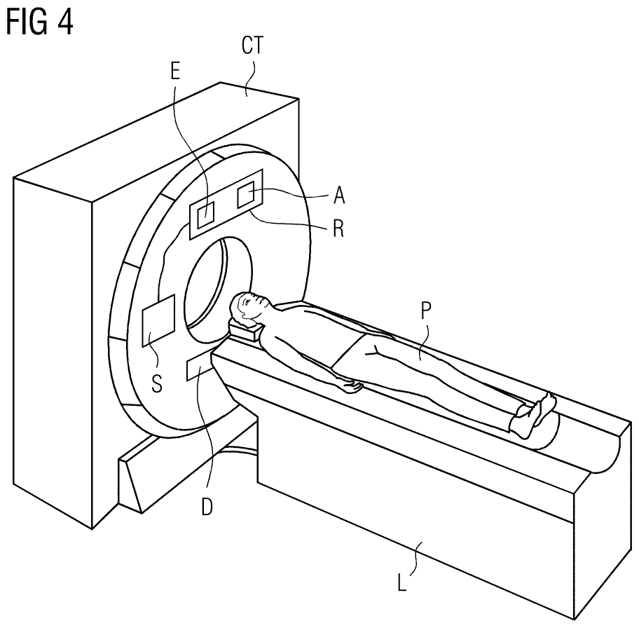

FIG. 4 depicts an X-ray tube R in an embodiment. The X-ray tube R includes an anode A, a first switching device, a second switching device, a control unit S, and an emitter E with multiple field effect emitter needles F1, F2, FN. At least one field effect emitter needle of the multiple field effect emitter needles F1, F2, FN includes a diameter of less than 1 μm and silicon. A first group G1 of the multiple field effect emitter needles F1, F2, FN may be activated or deactivated by the first switching device. A second group G2 of the multiple field effect emitter needles F1, F2, FN may be activated or deactivated by the second switching device. The first group G1 differs from the second group G2. The control unit S is configured to actuate the first switching device and the second switching device. The control unit S may be part of the X-ray tube R or be arranged outside the X-ray tube R. The control unit S may include an FPGA or a processor. In this embodiment the control unit S is arranged outside the X-ray tube R and is connected to the X-ray tube for actuating the first switching device and the second switching device.

The first switching device and/or the second switching device may be configured for an activation of the respective multiple field effect emitter needles F1, F2, FN, such that each activated field effect emitter needle supplies a saturation voltage.

The X-ray device includes the X-ray tube R and an X-ray detector D. The X-ray device is configured for an imaging examination with an alternating acceleration voltage. The acceleration voltage alternates during the imaging examination, for example in accordance with the dual-energy measuring protocol. In the embodiment the X-ray device is shown as part of a single-source computed tomography system CT. A patient P is arranged on a patient couch L.

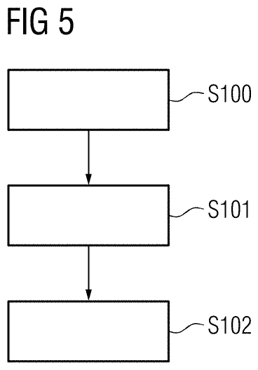

FIG. 5 depicts a flow diagram of a method for generating X-ray radiation in a predefined spatial distribution on an anode.

Method step S100 includes a predefinition of the spatial distribution of electrons striking the anode of an X-ray tube.

Method step S101 includes a selection of a group of multiple field effect emitter needles of an emitter of the X-ray tube as a function of an acceleration voltage.

Method step S102 includes an activation of the selected group of multiple field effect emitter needles, as a result of which X-ray radiation is generated in the predefined spatial distribution on the anode.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An X-ray tube comprising:
an anode;
a first switching device;
a second switching device;
a control unit, the control unit configured to actuate the first switching device and the second switching device; and
an emitter comprising multiple field effect emitter needles;
wherein at least one field effect emitter needle of the multiple field effect emitter needles includes a diameter of less than 1 μm and silicon;
wherein a first group of the multiple field effect emitter needles may be activated or deactivated by the first switching device;
wherein a second group of the multiple field effect emitter needles may be activated or deactivated by the second switching device; and
wherein the first group differs from the second group.

2. The X-ray tube of claim 1, wherein the first group differs from the second group in an arrangement of the multiple field effect emitter needles.

3. The X-ray tube of claim 2, wherein the first group differs from the second group in a number of the multiple field effect emitter needles.

4. The X-ray tube of claim 1, wherein the first group differs from the second group in an acceleration voltage applied.

5. The X-ray tube of claim 4, wherein the first group differs from the second group in a number of the multiple field effect emitter needles.

6. The X-ray tube of claim 5, wherein the first group differs from the second group in an arrangement of the multiple field effect emitter needles.

7. The X-ray tube of claim 1, wherein the first switching device, the second switching device, or the first switching device and the second switching device are configured for activating the respective multiple field effect emitter needle such that each activated field effect emitter needle supplies a saturation current.

8. The X-ray tube of claim 1, wherein the X-ray tube is configured to function with an X-ray device configured for an imaging examination with an alternating acceleration voltage.

9. A method for generating X-ray radiation in a predefined spatial distribution on an anode, the method comprising:
predefining the spatial distribution of electrons striking the anode of an X-ray tube;
selecting a group of multiple field effect emitter needles of an emitter (E) of the X-ray tube as a function of an acceleration voltage; and
activating the selected group of multiple field effect emitter needles;
wherein as a result of the activation, X-ray radiation is generated in the predefined spatial distribution on the anode.

10. The method of claim 9, wherein activating the selected group of multiple field effect emitter needles comprises activating the selected group of multiple field effect emitter needle such that each activated field effect emitter needle supplies a saturation current.

11. A non-transitory computer implemented storage medium that stores machine-readable instructions executable by at least one processor for generating X-ray radiation in a predefined spatial distribution on an anode, the machine-readable instructions comprising:
predefining the spatial distribution of electrons striking the anode of an X-ray tube;
selecting a group of multiple field effect emitter needles of an emitter (E) of the X-ray tube as a function of an acceleration voltage; and
activating the selected group of multiple field effect emitter needles;
wherein as a result of the activation, X-ray radiation is generated in the predefined spatial distribution on the anode.

12. The non-transitory computer implemented storage medium of claim 11, wherein activating the selected group of multiple field effect emitter needles comprises activating the respective group of multiple field effect emitter needle such that each activated field effect emitter needle supplies a saturation current.
